(19) United States
(12) Patent Application Publication
(10) Pub. No.: US 2016/0246645 A1
(43) Pub. Date: Aug. 25, 2016

(54) PARALLEL UTILIZATION OF AN ELECTRONIC DEVICE

(71) Applicant: Calay Venture S.à r. I., Bettembourg (LU)

(72) Inventor: Cevat Yerli, Frankfurt am Main (DE)

(73) Assignee: Calay Venture S.à. r. I., Bettembourg (LU)

(21) Appl. No.: 14/629,268

(22) Filed: Feb. 23, 2015

(51) Int. Cl. G06F 9/48; G06F 9/46

(52) U.S. Cl. CPC G06F 9/4881; G06F 9/466

(57) ABSTRACT

A method of parallel utilization of an electronic device is disclosed. The method comprises concurrently processing a first operation and a second operation, and responsive to determining that the second operation is complete, enabling a user to terminate the processing of the first operation.

### FIELD

The present disclosure relates to a method of parallel utilization of an electronic device processing an operation, and to a system allowing parallel utilization of operations.

### BACKGROUND

When an electronic device is processing some operation, such as a download or a computation, a user is typically blocked from other utilization of the electronic device and simply has to wait for the completion of the operation. Thereby, users may lose time to effectively operate the device.

To provide the user with some assessment of how long the processing will be continuing, process indices are used to help the user visualize the progress that is being made during some extended operation, such as a download, a file save, an update, a buffering process, and others.

By means of such process index, a user can estimate the time the operation will hold on, and he or she can take the time for some intermediate activity such as making a telephone call, reading a book, taking a rest or preparing some coffee, etc. However, during the processing, the user cannot take advantage of the electronic device. Moreover, the processing time often depends on varying external conditions, so that the previsions of the processing time as indicated by the bars are imprecise. As a consequence, the user cannot precisely adapt the intermediate activity to the actual duration of the processing, which may result in unfavorable time management.

There is, therefore, a need for a technique supporting an improved bridging of process time of an operation on an electronic device.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to a first aspect of the present disclosure, a method of parallel utilization of an electronic device comprises concurrently processing a first operation and a second operation, and responsive to determining that the second operation has been completed, enabling a user to terminate the first operation.

According to a second aspect of the present disclosure, an electronic device allowing parallel utilization is provided, the electronic device comprising at least one processor. The device is adapted to (e.g., via suitable programming of the device) concurrently process a first operation and a second operation, and to enable a user to terminate the first operation when the second operation has been completed.

The method and the electronic device of the present disclosure thus allow a time-saving bridging of the time the electronic device processes the second operation. For example, the completion of the second operation may be a requirement for performing a particular action a user is requesting. Accordingly, the user may have to wait for the completion of the second operation. However, the processing of the second operation may appear, to the user, as a background activity, while the user may take advantage of the first operation. As soon as the second operation is complete, the user is enabled to abandon the first operation, which operation may be of less importance to the user than the second one, such as to initiate the particular action. Consequently, the user is enabled to expediently use the time the second operation is being processed and thus, in total, to save time and enable a more efficient operation of the electronic device.

According to an embodiment, enabling the user to terminate the first operation comprises signaling that the second operation has been completed, such as by providing an optical or acoustical signal or both such signals. Accordingly, the user is released from repeatedly controlling the status of the second operation, as he or she becomes aware when the second operation has been completed even if he or she is fully concentrated on the first operation.

The electronic device as referred to herein may be a smartphone, a PC, a notebook computer, a tablet computer, or any other electronic device that includes at least one processor, a display, and one or more input devices, and is capable of processing operations.

The first operation may be associated with digital content, such as streaming content. For example, the first operation may comprise rendering a video or music, or it may include providing a video game on the electronic device. The digital content may, for instance, be defined by data which may be stored in a memory included in or connected to the electronic device, or which may be pre-cached, streamed, or downloaded via a network to the electronic device.

Enabling the user to terminate the first operation may comprise providing (e.g., upon determining that the second operation is complete) interactive means for controlling the first operation.

For instance, a user interface may be rendered. The user interface may be receptive to user input manipulating the processing of the first operation. The method may further comprise receiving, by means of the user interface, user input related to terminating, aborting, or interrupting the first operation, and accordingly terminating, aborting, or interrupting the first operation. Analogously, the electronic device may be adapted to such receiving user input and terminating, aborting, or interrupting the first operation.

The method may additionally comprise storing a time stamp identifying a portion of the first operation which has already been processed at the time the user input is received. The time stamp may allow for continuing, responsive to respective user input, the processing of the first operation from the time indicated by the time stamp once the first operation has been interrupted. Accordingly, after a while, the user may proceed with the first operation without having to repeat the portion that has already been processed. Analogously, the electronic device according to the second aspect of the present disclosure may be adapted to such storing of a time stamp.

The second operation may comprise one or more of: a download of data, such as one or more predetermined or user-selected data packages, via a network or other device connected with the electronic device (by wire or wirelessly), one or more file saves, at least one update operation, at least one buffering or caching operation, etc. In particular, the second operation may comprise downloading data initializing a video game. Accordingly, the second operation may be complete when the data has been entirely downloaded, when the one or more files are saved, or when predetermined or user-selected data, which may be portioned in one or more data packages, is updated, buffered or cached.

The second operation may cache content that is downloaded while the first operation is being processed. Additionally or alternatively, the second operation may operate local content that is available as a download from a hard disk drive or other storage medium.

As a particular example, the second operation may process game data of a video game, image data of a video, audio data, and/or other data.

According to an embodiment of the present disclosure, the first and the second operation relate to a common context. For instance, the first operation may comprise rendering a video trailer of a video game, game data of which may be loaded by the second operation.

The method according to the present disclosure may comprise monitoring a progress of the processing of the second operation so as to determine whether or not said processing is complete. Preferably, a graphical representation related to of the processing of the second operation may be provided, e.g., on a display of the electronic device.

The graphical representation may include an indication of a progress of the processing of the second operation.

In particular, the graphical representation may include a graphical process index and/or a numerical value (such as a percentage), respectively indicating a current proportion of the second operation which so far (e.g., at the calculation time) has already been processed as compared to the total of the second operation to be processed. The current proportion may be calculated repeatedly (e.g., periodically).

As used herein, a graphical process index may have any of different formats, varying, e.g., in their shape, such as linear bars, circles, etc., in the unit of measurement in relation to time, such as minutes/seconds remaining, percentage or portion filled or remaining in a linear bar or circle, and/or motion, such as static, linear movement, spinning, or flashing, or any suitable combination.

The graphical representation related to the processing of the second operation may include a timeline related to a processing time of the second operation, the timeline indicating one or more of: a time the second operation is currently being processed; an estimated remaining time for finishing the processing of the second operation; a minimum remaining time for finishing the processing. Additionally or alternatively, one or more time specifications may be displayed, the time specifications indicating one or more of: the process time so far, the estimated remaining time, the minimum remaining time as one or more numerical values, e.g., as respective numbers of seconds and/or minutes.

Accordingly, a user can trace the procedure of the second operation and estimate its further duration.

According to an embodiment, the method comprises updating the graphical representation related to the second operation. Thereby, the user is enabled to be aware of a current status of the second operation.

Analogously to the above mentioned graphical representation related to the processing of the second operation, a graphical representation related to the processing of the first operation may be provided, e.g., on a display of the electronic device.

The graphical representation related to the processing of the first operation may include an indication of the progress of the first operation. In particular, a current proportion of the first operation which so far, e.g., at the respective time, has already been processed as compared to the total of the first operation to be processed may be calculated (preferably periodically), and the graphical representation may include an indication of this current proportion, such as a graphical process index or a numerical value (such as a percentage) related to the first operation or both; as mentioned above, a graphical process index may take one of a plurality of possible formats and appearances.

Likewise, a timeline or at least one time specification related to the first operation may be displayed on the electronic device. Said timeline may be configured according to the above mentioned timeline and time specifications related to the second operation as described above, in any combination. The configuration of both timelines of the first and second operations may be the same or different from each other.

Accordingly, a user can, in particular, foresee a progress and/or a remaining processing time of the first operation, which may be useful to decide whether or not to terminate the processing of the first operation when the processing of the second operation is complete.

The method may comprise updating the graphical representation related to the first operation. Thus, the user is aware of a current status of the first operation.

The graphical representations related to the first operation and to the second operation, respectively, may be merged with each other to form a single user interface. Hence, the user interface may represent a unified user interface combining control and management of the first and second operations.

According to an embodiment, one or more user interfaces are provided, for example, within the graphical representation related to the processing of the first operation. The user interfaces may provide interactive elements enabling one or more of a pause, play, time slip (the ability to jump to a specific time point in content), and stop functions with respect to the processing of the first operation. Accordingly, means may be provided, such as the interactive elements, allowing for interfering and controlling of the first operation while it is being processed concurrently to the second operation.

According to a further aspect of the present disclosure, a computer-readable medium having instructions stored thereon is provided, wherein said instructions, in response to execution by a computing device, cause said computing device to automatically perform a method for parallel utilization of the computing device according to one or more embodiments of present disclosure. In particular, the computing device may be configured to automatically perform the steps of concurrently processing a first operation and a second operation, and responsive to determining that the second operation is complete, enabling a user to terminate the processing of the first operation.

According to yet another aspect of the present disclosure, a system including an electronic device according to embodiments of the present disclosure is provided.

As is to be understood, some or several of the features described herein may be combined with each other. In particular, the system according to the second aspect of the present disclosure may be adapted to carry out one or more of the particular embodiments of the method according to the first aspect of the present disclosure.

### BRIEF DESCRIPTION OF THE DRAWINGS

Further features and advantages of the present invention, as well as the structure and operation of various illustrative embodiments are described in more detail below with reference to the accompanying schematic drawings, wherein

FIG. 1 schematically depicts an exemplary method configured in accordance with the present disclosure;

FIG. 2a depicts an exemplary device configured in accordance with the present disclosure; and

FIG. 2b depicts the exemplary device of FIG. 2a at another point in time.

### DETAILED DESCRIPTION

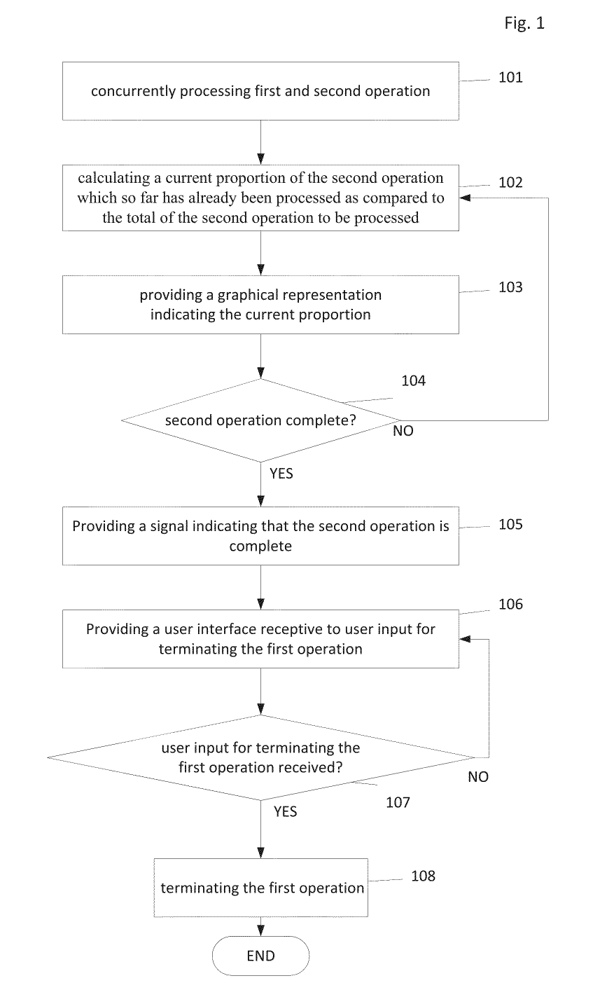

As shown in FIG. 1, a method in accordance with the present disclosure may include a step 101 of concurrently processing a first and a second operation. The first and second operation may, for instance, include an operation of rendering content, such as a video, or a data download operation, respectively. As depicted in step 106 of FIG. 1, upon determining in step 104 that the second operation (e.g., the download) has been completed, the user is enabled to terminate the processing of the first operation (e.g., the rendering of content).

In the exemplary embodiment shown in FIG. 1, said enabling is realized by providing, in step 106, a user interface which is receptive to user input for terminating the first operation. In step 107 it is checked whether such user input has been received. If so, the first operation is terminated in step 108, otherwise (as indicated by the arrow returning from step 107 to step 106) the user interface is maintained such that the user can operate the user interface to terminate the first operation later on. According to an alternative embodiment, the user interface might disappear once the user has decided to not (actively) terminate the first operation, e.g., when the user wishes to continue consuming data rendered by the first operation until it is finished, such as to thereafter turn to data downloaded as the second operation, for instance.

The user interface may form part of a bar displayed when the first operation is being processed, the bar indicating a progress or providing a timeline for the first operation. Alternatively, the progress may be illustrated in the form of a circle including a sector indicating a progress or time portion. For instance, when the first operation is related to rendering content such as video, music or a video game, the bar or circle may provide a visual indication of one or more of an amount of content that is available to view, content that has already been viewed, the current progress and position of content currently playing, and content that through pre-caching is available to be viewed. The bar may provide a pause, play, time slip, and stop function with respect to the first operation. These functions may work independently of the concurrently processed second operation.

The exemplary method shown in FIG. 1 further includes step 105, in which a signal is provided to the user, so as to indicate that the second operation is complete. Such signal may be an optical signal such as a flashing light or a window or button popping up at a display of the electronic device. In particular, the optical signal may be included in the above mentioned user interface for terminating the first operation. Additionally or alternatively, the signal may be an acoustical alarm, such as a beep sounding when the second operation has been completed. Accordingly, the user is relieved from actively controlling the progress of the second operation and can concentrate on the first operation.

The embodiment depicted in FIG. 1 further includes a step 102 of calculating a current proportion of the second operation which so far has been processed as compared to the total of the second operation to be processed, and a step 103 of providing a graphical representation related to the second operation and indicating the current proportion. Such graphical representation may be, for instance, a bar or circle or a numerical ratio (such as a percentage) providing a simplified view of the progress of the second operation. In the exemplary case that the second operation relates to a data download, the graphical representation may, for example, indicate an amount of caching content that is downloading concurrently to the first operation, or an amount of local content that is available as a download from a hard disk drive or other local storage medium, or the like.

Accordingly, the user may observe the progress of the second operation, e.g., of a download, such as to estimate its success and its further duration.

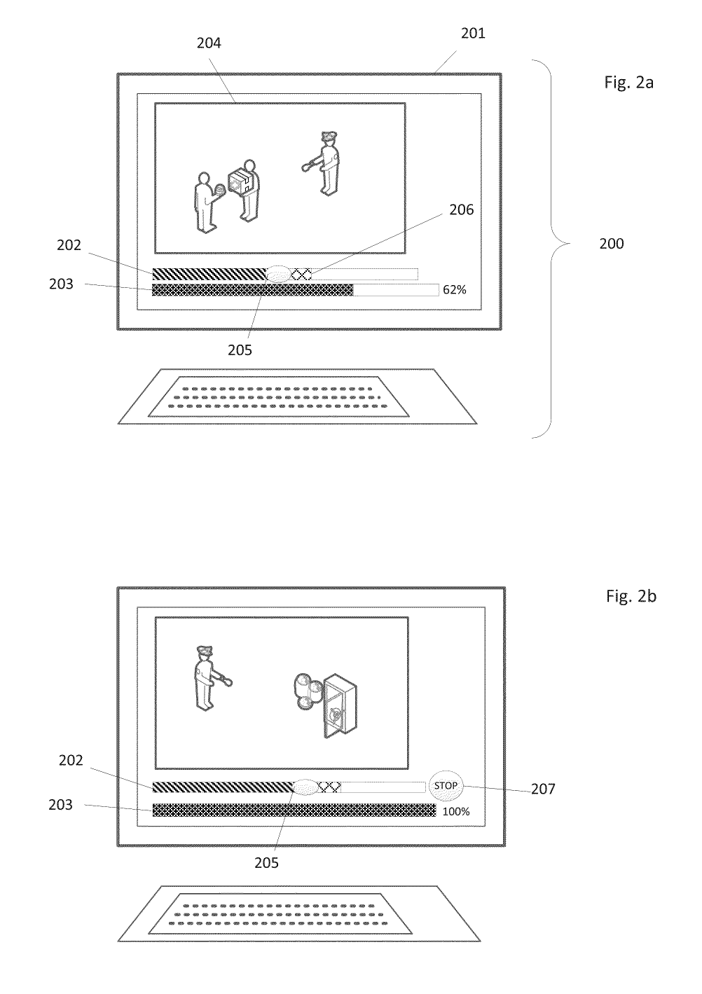

FIGS. 2a and 2b show an exemplary electronic device in accordance with an embodiment of the present disclosure. Therein, FIGS. 2a and 2b may refer to different points in time. The electronic device 200 may be connected to a computer network (not shown).

The electronic device 200 includes a display 201 rendering graphical representations including process indices 202 and 203 illustrating a progress of a first and second operation, respectively, which operations are concurrently processed by the device 200. In the shown exemplary embodiment, process indices 202 and 203 are shaped as linear bars. Alternatively or additionally, process indices illustrating the progress might be respective circles including a marked sector, for example.

The marked portion within the bar of process index 203 illustrates the progress of the second operation at the depicted point in time, which, in FIG. 2a, amounts to 62% of the total of the second operation, as further numerically indicated in the exemplary embodiment.

The bar of process index 202 illustrates the progress of the first operation which, in the schematically shown example, comprises rendering a video within window 204. The position of moving button 205 within the total bar of process index 202 illustrates a position of the scene which is being displayed, as compared to the total video. Preferably, the user can shift the button 205 in order to jump forward or backward within the rendering of the available portion of the video. The marked portion 206 at the right of button indicates an amount of pre-cached video data. Accordingly, the marked portions at the left and the right of button 205 indicate the portion of the video data which is available at the respective point in time.

As mentioned above, alternatively to rendering a video, the first operation might relate to providing other content, such as a video game or rendering music, or downloading content, or some other operation.

FIG. 2b relates to a later point in time than FIG. 2a, when the processing of the second operation has been completed, as evident by the now entirely marked bar of index 203 and further by the numerical indication of “100%.” In accordance with the present disclosure, as the processing of the second operation is now complete, the user is enabled to terminate the first operation. This may be done by a user shifting button 205 to the right of the bar 202. In the exemplary embodiment shown in FIG. 2, a stop button 207 has popped up at the point in time depicted in FIG. 2b. The stop button may serve as an optical signal indicating the user that the second operation is complete, which may additionally or alternatively be indicated by an acoustic signal. The stop button may further function as a user interface such that, when the user clicks on the button, the first operation is terminated.

While some embodiments have been described in detail, it is to be understood that aspects of the disclosure can take many forms. In particular, the claimed subject matter may be practiced or implemented differently from the examples described, and the described features and characteristics may be practiced or implemented in any combination. The embodiments shown herein are intended to illustrate rather than to limit the invention as defined by the claims.

The embodiments of the invention in which an exclusive property or privilege is claimed are defined as follows:

1. A method of parallel utilization of an electronic device, the method comprising:
concurrently processing a first operation and a second operation; and
responsive to determining that the second operation is complete, enabling a user to terminate the processing of the first operation.

2. The method of claim 1, further comprising providing a graphical representation related to the processing of the second operation, the graphical representation comprising a graphical process index indicating a proportion of the second operation that has already been processed.

3. The method of claim 1, further comprising providing a graphical representation related to the processing of the first operation, the graphical representation comprising a graphical process index indicating a proportion of the first operation that has already been processed.

4. The method of claim 3, further comprising merging the graphical representation related to the first operation and a graphical representation related to the second operation with each other to form a single user interface.

5. The method of claim 1, further comprising rendering a user interface including interactive elements receptive to user input manipulating the processing of the first operation.

6. The method of claim 5, further comprising:
receiving, by means of the user interface, user input related to terminating the processing of the first operation; and
terminating the processing of the first operation.

7. The method of claim 6, further comprising storing a time stamp identifying a portion of the first operation which has already been processed when the user input is received.

8. The method of claim 1, wherein the first operation comprises an operation of rendering digital content.

9. The method of claim 8, wherein the digital content is at least partially defined by data that has been pre-cached, or by data that is downloaded via a network to the electronic device, or by data that is available from a hard disk drive or other local storage medium of the electronic device.

10. The method of claim 1, wherein the second operation comprises one or more of:
a download of data via a network to the electronic device;
a download of data from a cache;
a download of data that is available from a hard disk drive or from one or more other local storage media;
one or more file saves; and
at least one update operation.

11. An electronic device allowing parallel utilization of operations, the electronic device comprising a processor, wherein the device is adapted to:
concurrently process a first operation and a second operation; and
enable a user to terminate the processing of the first operation when the processing of the second operation has been completed.

12. The device of claim 11 further comprising a display, wherein the device is further adapted to provide via the display a graphical representation related to the processing of the second operation, the graphical representation comprising a timeline related to the processing time of the second operation.

13. The device of claim 11 further comprising a display, wherein the device is further adapted to provide via the display a graphical representation related to the processing of the first operation, the graphical representation comprising a timeline related to the processing time of the first operation.

14. The device of claim 13, wherein the graphical representation related to the first operation and a graphical representation related to the second operation are merged with each other to form a single user interface.

15. The device of claim 11, wherein the device is further adapted to render a user interface which is receptive to user input manipulating the processing of the first operation.

16. The device of claim 15, wherein the device is further adapted to terminate the processing of the first operation upon receiving, via the user interface, user input related to terminating the processing of the first operation.

17. The device of claim 16, wherein the device is further adapted to store a time stamp identifying a portion of the first operation which has already been processed in response to user input related to terminating the processing of the first operation.

18. The device of claim 11, wherein the first operation comprises an operation of rendering digital content.

19. The device of claim 18, wherein the digital content is at least partially defined by data that has been pre-cached on a local storage medium of the device.

20. The device of claim 11, wherein the second operation comprises one or more of:
download of data via a network to the device;
download of data from a cache;
download of data that is available from a hard disk drive or from one or more other local storage media;
one or more file saves; and
at least one update operation.
